(19) United States
(12) Patent Application Publication
(10) Pub. No.: US 2007/0034291 A1
(43) Pub. Date: Feb. 15, 2007

(54) Profile cutting tool and method of sharpening

(76) Inventors: Michael R. Moran, Nampa, ID (US); Michael R. Swenson, Nampa, ID (US)

Correspondence Address: TRASK BRITT, P.O. BOX 2550, SALT LAKE CITY, UT, 84110, US

(21) Appl. No.: 11/504,816

(22) Filed: Aug. 15, 2006

Related U.S. Application Data
(60) Provisional application No. 60/708,229, filed on Aug. 15, 2005.

(51) Int. Cl. B26D 1/12

(52) U.S. Cl. 144/218; 407/48; 144/91.2; 144/234

(57) ABSTRACT

A knife for cutting a profile including a curved surface in a workpiece may comprise a cutting face including a cutting edge in the shape of the profile to be cut, a bore for mounting the knife on a rotary cutterhead, the bore oriented parallel to the substantially planar cutting face, and a back surface adjacent the cutting face and including the cutting edge, the back surface contoured in the shape of the profile and partially radially encompassing the bore. The knife may be sharpened by grinding the cutting face to expose a new cutting face. The back surface is in the shape of the profile, therefore each new cutting face includes a cutting edge with a substantially similar profile. Knives having tips of, for example, carbide may be radially interspersed on the rotary cutterhead between the profile knives.

### CROSS-REFERENCE TO RELATED APPLICATIONS

This application claims the benefit of U.S. Provisional Application Ser. No. 60/708,229 filed Aug. 15, 2005, the disclosure of which is incorporated in its entirety herein.

### BACKGROUND OF THE INVENTION

1. Field of the Invention

The present invention relates generally to rotating cutting devices and, more particularly, to a rotating head and a profile knife that can be sharpened without changing the original cutting profile.

2. State of the Art

A rotating head having removable cutting blades may be used to cut a profile in a workpiece. For example, a piece of wood may be cut with a profile to form a door molding. The head may have an arbor collar to hold the head about a rotating spindle. The arbor collar may comprise a high pressure grease fitting. The hydraulic pressure of the grease secures the head to the rotating spindle. Two or three cutting blades, known as knives or inserts, may be positioned about the perimeter of the head. Each knife conventionally comprises a polygonal blade having the desired cutting profile on the cutting edge. The cutting edge of the knife may extend beyond the head peripheral surface and remove a shaving from the workpiece as the head rotates. The thickness of the shaving depends on the advance rate of the workpiece and the rotational speed of the head.

The knives may become damaged or wear down during use, requiring replacement. Operating costs may depend on how long a knife remains sharp and free of damage. Holders for the knives may be inserted or removed from the head of the cutting device. However, conventional knife holders enable only a single position for the blade relative to the holder, and a re-sharpened blade may be a different size. Blade material may be removed during sharpening; therefore the blade may cut to a different depth if remaining in the same position. Thus, adjustment of the entire head may be required to continue the identical cutting profile. Profile cutting knives conventionally have only one cutting edge with a unique cutting shape, and therefore, cannot be turned to a different cutting edge when the first is dulled, as in the case of a stock polygonal knife having multiple cutting edges.

Accordingly, what is needed in the art is a profile knife which may be sharpened and re-used. An arbor collar which reliably transmits rotational force from the spindle to the head may additionally be useful. Knives for cutting a workpiece comprising layers of different materials are desirable.

### BRIEF SUMMARY OF THE INVENTION

The present invention relates to a knife having a profiled cutting edge, which may be re-sharpened. The knife may comprise a unitary wedge-shape, and include a substantially planar cutting face having a cutting edge in the shape of a profile to be cut into a workpiece. A bore through the knife enables the knife to be mounted on a rotary cutterhead, the bore being oriented parallel to, and offset from, the substantially planar cutting face. A back surface of the knife is adjacent the cutting face and includes the cutting edge, the back surface being contoured in the shape of the profile and partially radially encompassing the bore.

The back surface of the knife may include a concave or convex surface, and may include a depressed portion distal from the substantially planar cutting face. The depressed portion may be configured to provide an indicator of undue sharpening of the knife, to discourage use of the knife beyond the intended life. Optionally, the back surface may include a coating, for example of zirconium nitride thereon.

A cutterhead for cutting a profile in a workpiece may include an arbor collar and two annular end plates mounted to radially extend from a portion of each longitudinal end of the arbor collar. The annular end plates may have a plurality of spaced apertures therethrough, and an attachment element may be mounted through one of a plurality of apertures of the first plate and an aligned aperture of a plurality of apertures of the second plate. A knife as described above may be mounted on the attachment element between the plates, the attachment element extending within a bore through the knife. The attachment element may include an automotive taper for joining with the aperture of the plate. Thus, a surface of an end of the attachment element may be flush with an outer surface of the plate.

In one embodiment of the present invention, the arbor collar may include a star-shaped perimeter which interlocks with at least one plate of the two for rotationally driving the cutterhead. Additionally, the arbor collar may include a grease fitting on a circumferential surface thereof. High pressure grease may be inserted through the fitting, and the hydraulic pressure of the grease may secure the cutterhead to a rotating spindle. The surface of the arbor collar may expand radially inward with the pressure of the grease to grip the rotating spindle. Alternatively, a bore through the arbor collar may be tapered, and configured to mate with a tapered spindle, The tapered bore may secure the cutterhead to a rotating, tapered spindle.

A method of sharpening a profile knife may include providing a cutterhead having profile knives annularly attached thereto, grinding a cutting surface of each profile knife to provide a cutting edge in the shape of the curved profile to be cut in a workpiece, and aligning the plurality of profile knives with the cutting edge of each profile knife extending radially a substantially similar distance from the cutterhead.

Another embodiment of a knife for cutting a profile comprises a cutting face including a cutting edge having at least one protrusion and at least one valley, a bore through the knife for mounting the knife, the bore having an off-center position in the knife, and a back surface adjacent the cutting face and including the cutting edge, the back surface following the shape of the at least one protrusion and the at least one valley in cylindrical relief. The back surface of the knife may be concentric, sharing a common axis which is centrally located through the bore.

The back surface of the knife may include a depressed portion distal from the substantially planar cutting face. Additionally, the back surface may include a coating, for example zirconium nitride, thereon.

The cutting edge may comprise a plurality of erratic hills and valleys, and may be configured to form a woodgrain-like texture on a workpiece. Alternative cutting edges may comprise one or a plurality of concave or convex edges, right-angle corners, or substantially straight edges.

### BRIEF DESCRIPTION OF THE SEVERAL VIEWS OF THE DRAWINGS

The foregoing and other advantages of the present invention will become apparent upon review of the following detailed description and drawings in which:

FIG. 1 shows a cutterhead and knives of the present invention;

FIG. 2A shows a first embodiment of a knife of the present invention;

FIG. 2B shows a top view of the knife of FIG. 2A;

FIG. 2C shows a side view of the knife of FIG. 2A;

FIG. 2D shows a top view of a second embodiment of a knife of the present invention;

FIG. 3A shows a third embodiment of a knife of the present invention;

FIG. 3B shows a side view of the knife of FIG. 3A;

FIG. 3C shows a workpiece formed using the knife of FIG. 3A;

FIG. 4A depicts a fourth embodiment of a knife of the present invention;

FIG. 4B illustrates a top view of the knife of FIG. 4A

FIG. 5A shows a sharpening method for a knife of the present invention;

FIG. 5B depicts a fifth embodiment of a knife of the present invention;

FIG. 6A illustrate a cutterhead of the present invention;

FIG. 6B shows another view of the cutterhead of FIG. 6A;

FIG. 6C illustrates an attachment element of the cutterhead of FIG. 6A;

FIG. 7 shows a method of filling a grease fitting of the cutterhead of FIG. 6A;

FIG. 8A depicts an alignment tool and cutterhead of the present invention;

FIG. 8B depicts a side view of the alignment tool and cutterhead of FIG. 8A;

FIG. 9 illustrates another cutterhead of the present invention;

FIG. 10A depicts a sixth embodiment of a knife of the present invention;

FIG. 10B depicts a side view of the knife of FIG. 10A;

FIG. 11 illustrates a seventh embodiment of a knife of the present invention; and

FIG. 12 shows a stack of knives of the present invention.

### DETAILED DESCRIPTION OF THE INVENTION

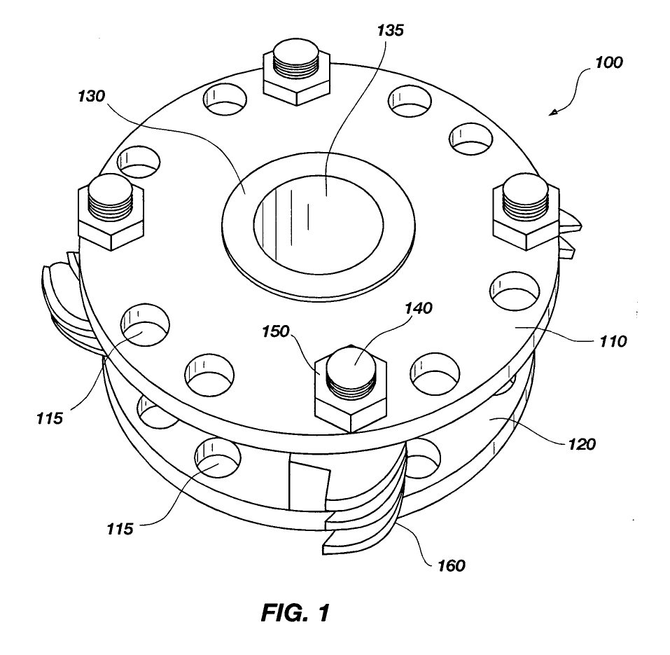

FIG. 1 shows a cutterhead 100 having a first, annular end plate 110 and a second, annular end plate 120 connected by an arbor collar 130. The arbor collar 130 may include an aperture 135 therethrough, enabling the cutterhead 100 to be mounted on a spindle (not shown) for rotation thereabout. The arbor collar 130 may comprise a high pressure grease fitting, to secure the arbor collar 130 about the spindle. Alternatively, the aperture 135 of the arbor collar 130 may include a taper, and the spindle may also include a taper, configured to matingly engage with the aperture 135 of the arbor collar 130. The spindle may be threaded, and a safety nut may secure the arbor collar 130 on the spindle.

The first end plate 110 and the second end plate 120 may each include a plurality of spaced apertures 115 about the perimeter thereof. The end plates may be circumferential, square, or any other suitable shape. The spaced apertures 115 of the annular end plates 110, 120 may be aligned, enabling attachment elements 140 to be placed therethrough, coupling the first end plate 110 and the second end plate 120. The attachment elements 140 may be, for example bolts or screws, and be secured by nuts 150. The attachment elements 140 may be, by way of example, ⅝-inch in diameter, a non-conventional size. Attachment elements 140 of any size diameter are within the scope of the invention. Attachment elements 140 having a non-circular transverse cross-sectional shape are additionally within the scope of the present invention. For example, the cross-sectional shape of the attachment elements 140 may be elliptical, triangular, square, or hexagonal.

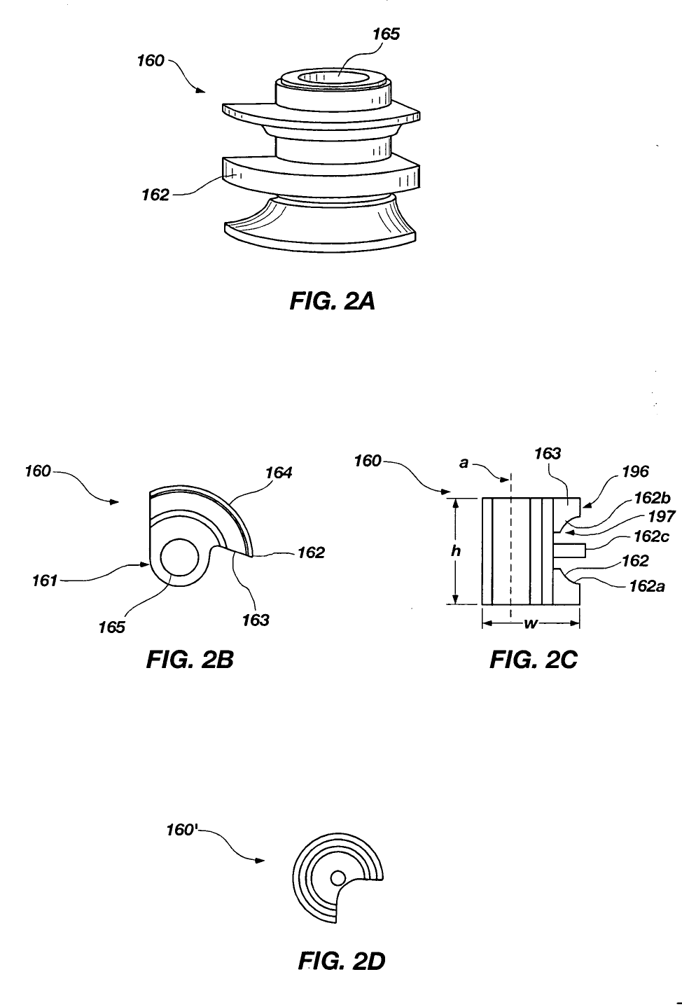

A knife 160 may be mounted on an attachment element 140 and positioned between the first end plate 110 and the second end plate 120. The knife 160, shown in detail in FIGS. 2A through 2C, may include a bore 165 therethrough, for mounting the knife 160 on the attachment element 140. The knife 160 may have the approximate shape of a wedge from a cylinder, and the bore 165 may extend longitudinally through a corner 161 of the knife 160, the corner 161 being the portion of the wedge-shape proximate the central axis of the cylinder from which the wedge-shape is derived. Thus, the bore 165 extends through the knife 160 in an off-center location. The corner 161 may be chamfered. Optionally, the knife 160 may have the approximate shape of a half cylinder, cut longitudinally, or a cylinder with a quarter-wedge missing. FIG. 2D depicts a side view of a knife 160′ with the approximate shape of a cylinder with a quarter-wedge missing.

Returning to FIGS. 2A through 2C, a cutting face 163 of the knife 160 may have a cutting edge 162 in the shape of the desired profile to be cut on the workpiece. The cutting face 163 may approximately follow a radial surface of the wedge-shape.

Illustrated in FIG. 2B is a profile view of the knife 160, looking through the bore 165. This profile may be a claw-shape. The cutting edge 162 need not precisely follow a radius line from the center of the bore 165 to a back surface 164, the back surface 164 being the circumferential surface of the wedge-shape; rather the cutting edge 162 may be hooked to attack the surface of the workpiece. The hook angle of the cutting edge may vary, for example, according to the density or hardness of the workpiece material.

The bore 165 through the knife 160 is in an off-center location with respect to the rotational center of mass of the knife 160. However, the back surface 164 of the knife is concentric, sharing a common center axis at which is a central axis of the bore 165. (FIG. 2C) Thus, following sharpening, as described hereinbelow, the cutting edge 162 will always be equidistant from the bore 165. The knife 160 may be envisioned as a wedge from a cylinder, with the bore 165 as a central axis through the cylinder. The bore is therefore in an off-center location through the knife 160.

Illustrated in FIG. 2C is another profile view of the knife 160, a longitudinal profile of the bore 165. The desired profile shape of the cutting edge 162 is shown, the desired profile shape including curved edges. The back surface 164 of the knife 160 is defined on one edge by the cutting edge 162. The desired profile shape may further define the contour of the back surface 164. The profile shape of this embodiment of a knife 160 according to the present invention and as depicted in FIGS. 2A-2C, includes a plurality of protrusions 196 and valleys 197. The plurality of protrusions and valleys are defined by a first concave portion 162a, a second concave portion 162b, and a right-angled portion 162c positioned between the first concave portion 162a and the second concave portion 162b. It will be understood by one of ordinary skill in the art that any profile shape is within the scope of the present invention, including curved edges, as well as straight-line edges. The resulting profile shape of the workpiece may include, for example, a concave or a convex surface, as well as a flat surface, meeting at right, acute, or obtuse angles. The profile shape may be planar, or may be textured. The profile shape may be, for example, the desired shape of a molding. The profile shape may be, for example, a finger joint profile.

The knife 160 may comprise a high speed steel, such as a blend of tool steel that uses the alloying elements Molybdenum, Chromium, Vanadium, Tungsten, and Cobalt, for example, A.I.S.I. (American Iron and Steel Institute) M-2. Another suitable material may be A.I.S.I. M-42, a grade of high speed steel with a high content of cobalt in the alloy.

The knife 160 may comprise a unitary body, and may have a height h of between about half of the width w and about twice the width w. The knife 160 may thus have a height h which encompasses a cutting edge 162 including at least one protrusion 196 and/or at least one valley 197.

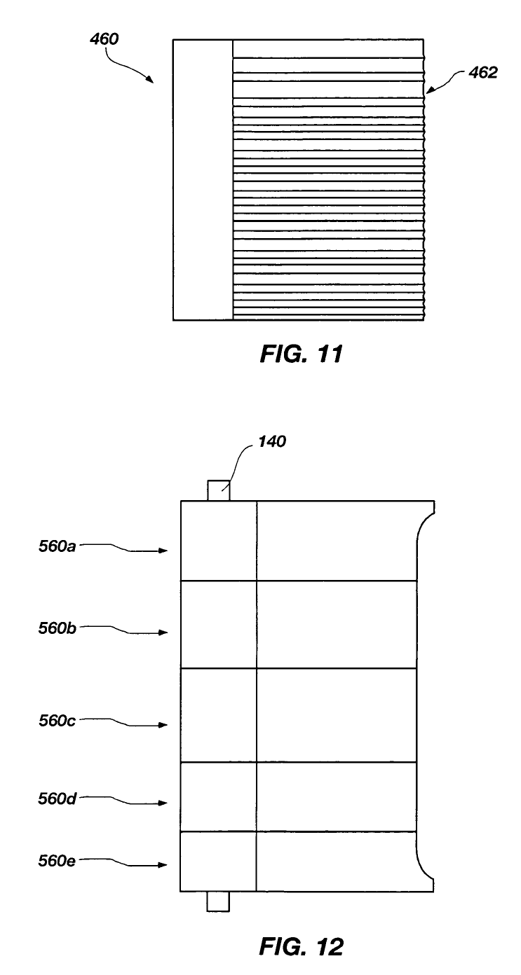

Optionally, a knife 360 may include a coating 190, as shown in FIGS. 10A and 10B. The coating 190 may be a ceramic coating comprising, for example, zirconium nitride, which may be deposited by physical vapor deposition. Other examples of suitable coatings include chromium, titanium nitride, titanium carbo nitride, titanium aluminum nitride, chromium nitride, and a diamond coating. A nanoparticle coating, for example one sold under the trade name NanoTek® by Nanophase Technologies of Romeoville, Ill. may be suitable. The entire knife 360 may be coated, and the cutting face 363 of the knife 360 may be ground to take the coating off. The material of the coating 190 may be “cooked” into the material of the body of the knife 360, impregnating the knife material at a temperature of about 900° Fahrenheit. Impregnated coatings 190 do not add significant quantities of material to the knife 360, and do not alter the tolerance of the knife 360.

The material of coating 190 may be harder than the material of the body of the knife 360. As the knife 360 is used to cut material, for example wood or a synthetic wood product, the material of the body of the knife 360 may wear away faster than the material of the coating 190. The coating 190 may form a sharp cutting edge 195 which protrudes from the cutting face 363 of the knife, and which may be characterized as a “lip.” The knife 360 having a coating 190 thereon may thus be self-sharpening. In conventional finger joint knives and in conventional profile cutting knives, the material at the cutting edge is very thin, and the knife becomes very hot with use due to contact with the workpiece. Coatings of convention knives may thus degrade. For example, a diamond coating will begin to break down at a temperature of about 750° Fahrenheit.

The knife 360 has a cylindrical relief, that is, the profile of the knife continues, in a cylindrical form, about the bore 365 in the knife 360. In comparison with conventional knives, there is a substantially greater mass of material behind the cutting edge 363 of a knife 360 of the present invention, having cylindrical relief. Thus, as heat is generated during use, the body of the knife 360 acts as a heat sink, and the cutting edge 363 does not overheat. The knife 360 may cut for 1,100 hours without sharpening and without overheating and degrading the coating 190. The knife 360 may efficiently cut through a harder wood, or through a glue line of a laminate workpiece, without the need for a separate tip, such as a carbide tip as described hereinbelow. The thickness of the coating 190 has been exaggerated in FIGS. 10A and 10B for clarity. FIG. 10B depicts another cutting profile design, a V-shaped profile, for a knife of the present invention.

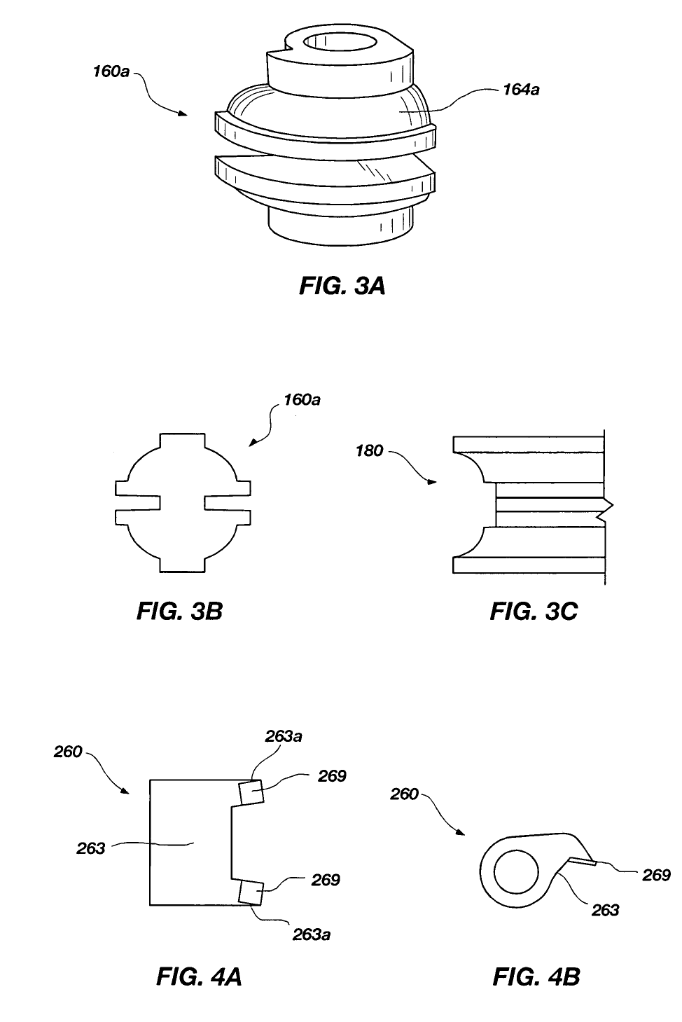

FIG. 3A depicts a perspective view of another embodiment of a knife 160a of the present invention. The knife 160a includes a different profile shape, the back surface 164a of the knife 160a having two convex portions. A profile view of the knife 160a is shown in FIG. 3B. FIG. 3C depicts a profile view of a workpiece 180 formed using the knife 160a.

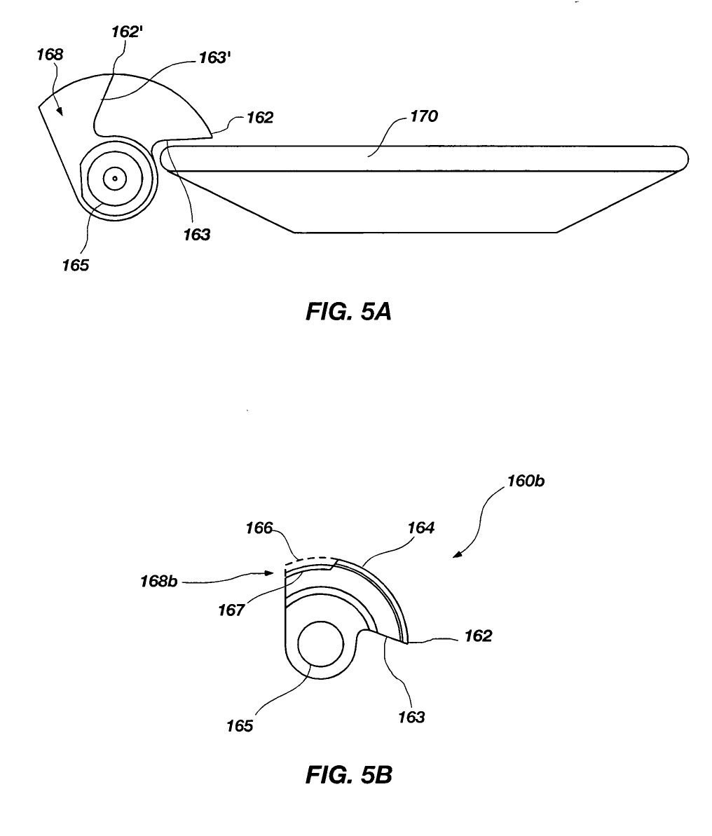

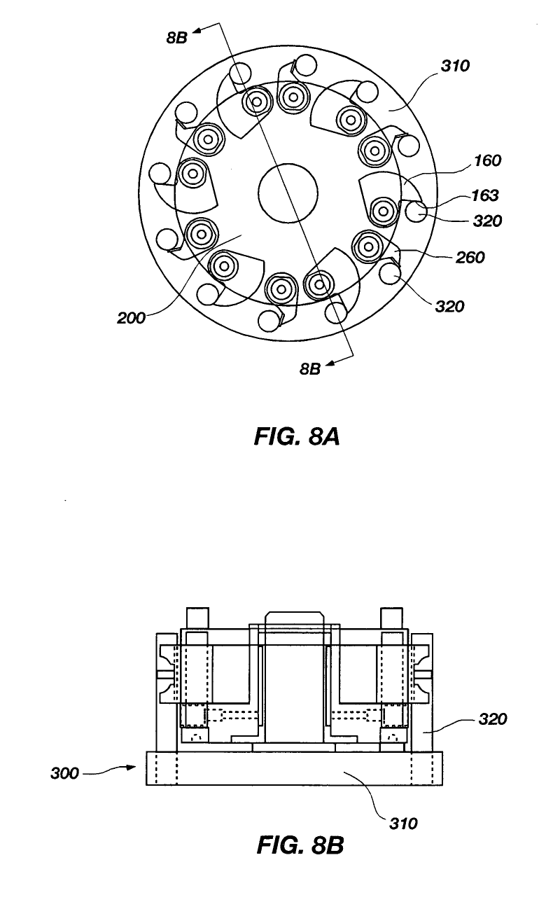

Yet another embodiment of a knife 260 of the present invention is shown in FIGS. 4A and 4B. The cutting face 263 of knife 260 has two teeth, 263a, each with a separable tip 269 of a harder material, for example, carbide. The separable tip 269 may more efficiently cut through a harder wood, or a glue line of a laminate workpiece. The separable tip 269 may be attached to the knife 260 using an attachment member (not shown), for example a bolt or a screw, or using an adhesive. The knife 260 having a separable tip 269 may be circumferentially interspersed on a cutterhead 200, as shown in FIG. 8A, between knives 160. Thus, the cutting face of the knives 160, 260 together may be used to cut a desired profile in a workpiece. Optionally, a knife may include a cutting edge 162 having a profile wherein portions of the cutting face 163 have separable tips 269 thereon, similar to the knife 260 of FIGS. 4A and 4B, and portions of the cutting face 163 are formed of the unitary body of the knife, similar to the knives 160, 160a of FIGS. 2A through 2C and FIGS. 3A and 3B.

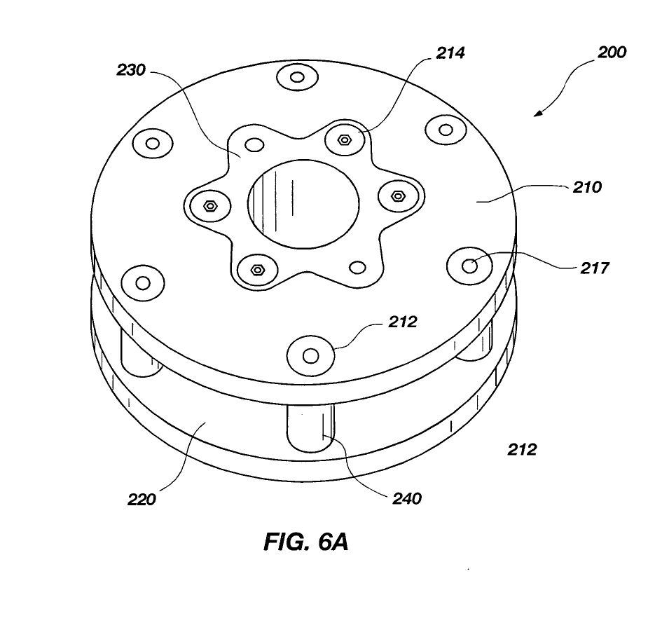

The knife 160 may be sharpened as shown in FIG. 5A. A grinding wheel 170 may be pressed against the cutting face 163 to sharpen the knife 160. By grinding the cutting face 163, the entire profile of the cutting edge 162 is uniformly sharpened. The knife 160 may be sharpened a number of times, each time removing a portion of a cutting face 163 of the knife 160 including the cutting edge 162, until a final cutting face 163′ and final cutting edge 162′ are exposed. Each time the knife 160 is sharpened, the knife 160 on the cutterhead 100 may be turned incrementally about the bore, placing the newly exposed cutting edge 162 in the exact position with respect to the cutterhead 100 as the previous cutting edge 162. Each sharpening may shave approximately 0.001 inch from the cutting face 163. The knives 160 may be sharpened in situ, on the cutterhead. In contrast, conventional knives must be removed from a cutterhead for sharpening.

Sharpening is described with respect to the knife 160; however, any embodiment of a knife of the present invention, including knife 160, 160′, 160a, 160b, 360, 460, 560, 660, 760 may be sharpened as described hereinabove.

Optionally, a heel 168 of the knife 160 may be shaped as shown in FIG. 5B such that further sharpening beyond the final cutting edge 162′ will not leave a long enough cutting edge 162, and the knife 160 must be replaced. The may prevent the knife 160 from being used when too little of the heel 168 of the knife 160 remains, risking fracture of the knife 160. The heel 168 may be the portion of the knife 160 circumferentially distal from the cutting edge 162. Returning to FIG. 5A, the radial distance from the bore 165 to the back surface 164 is substantially equal across the arc of the knife. That is, the radial distance from the bore 168 to the back surface 164 at the cutting edge 162 is substantially similar to the radial distance from the bore 165 to the back surface 164 at the heel 168, unless the heel is reduced in volume as shown in FIG. 5B. This enables the knife 160 to be sharpened, rolled forward about the bore 165, and to provide a cutting edge 162′ in substantially the same position as the pre-sharpened cutting edge 162. If the radial distance from the bore 165 to the back surface 164 substantially differs in portions of the knife 160, the sharpened cutting edge 162′ will not match the position of the pre-sharpened cutting edge 162.

The knife 160b depicted in FIG. 5B includes a reduced-volume heel 168b, such that the back surface 164 is chamfered or depressed at the reduced-volume heel 168b. A chamfered portion 167 of the back surface 164 does not extend as far from the bore 165 as the back surface 164. The outline of a full volume heel is depicted with dashed line 166. Thus, sharpening the knife 160b beyond the final cutting surface 163′ causes the cutting edge 162 to include the chamfered portion 167 of the back surface 164, and the profile no longer matches the profile of the original cutting edge 162. This may discourage use of the knife 160b beyond the intended life.

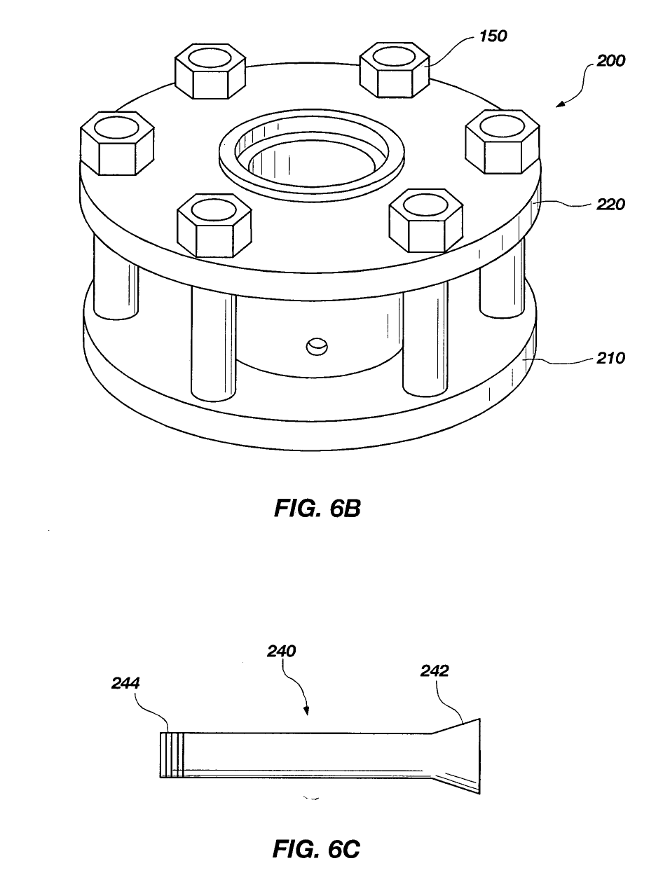

Another embodiment of the present invention, depicted in FIG. 6A, is a cutter head 200, including a first annular end plate 210 having a plurality of counterbores 212 for attachment elements 240. The counterbores 212 enable attachment elements 240 having a flange (not shown) at one end to be fitted therewithin, and the end of the attachment elements 240 may be flush with a surface 217 of the first end plate. Alternatively, the attachment elements 240 and counterbores 212 may have a taper, for example an automotive taper for mating the attachment elements 240 within the counterbores 212. FIG. 6C depicts an attachment element 240 having a tapered end 242. The longitudinal end of the attachment element 240 has the greatest circumference, preventing an attachment element 240 from passing through a counterbore 212. The opposite longitudinal end 244 may be threaded, for attachment to a nut 150, for example, or screwed into a threaded bore 115 of the annular end plate 220. A safety arbor collar 230 has a star-shaped perimeter 214, preventing the first end plate 210 from slipping on the safety arbor collar 230, even if the hydraulic pressure of the grease fitting is not maintained. The star-shaped perimeter provides a drive mechanism, transferring the rotation of the spindle from the arbor collar to the first end plate 210. Another perspective view of the cutter head 200 is shown in FIG. 6B.

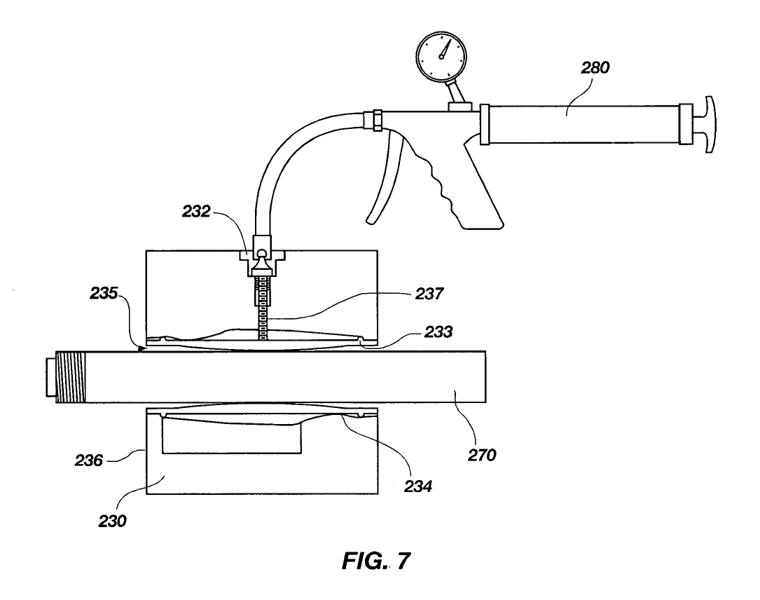

The arbor collar 230 may further include a grease fitting 232 on the circumferential perimeter thereof, as shown in FIG. 6B. FIG. 7 depicts the arbor collar 230 mounted on a spindle 270. A grease gun 280 may be used to fill an annular chamber 234 surrounding the bore 235 of the arbor collar 230 with high pressure grease through the grease fitting 232, causing the wall 233 defining the bore 235 of the arbor collar to expand radially inward and seize the spindle 270. The grease fitting 232 mounted on the circumferential perimeter of the arbor collar enable the tube 237 for transporting the grease to the annular chamber 234 surrounding the bore 235 to be shorter in length compared to a conventional tube, attached to grease fittings on the longitudinal end surface 236 of the arbor collar, proximate an annular end plate of the cutterhead. Conventional cutter heads may have grease fittings on a circumferential edge of the annular end plate, and a fluid pathway for grease may extend through the annular end plate to a fluid pathway within the conventional arbor collar.

Alternatively, the bore 235 of the arbor collar 230 may include a taper, and the spindle may also include a taper, configured to matingly engage with the bore 235 of the arbor collar 230. The star-shaped perimeter 214 of the safety arbor collar 230 may prevent the first end plate 210 from slipping on the safety arbor collar 230.

An alignment tool 300 is illustrated with the cutter head 200 in FIGS. 8A and 8B. The alignment tool 300 may include a support plate 310 and a plurality of alignment posts 320 spaced at radial intervals. The cutter head 200 may be placed on the alignment tool 300, and the knives 160 may be individually adjusted such that the cutting face 163 of each knife 160 is in contact with an alignment post 310. The knives may be simultaneously individually adjusted by loosening the nuts 150 securing the attachment elements 150, placing the cutterhead 200 on the alignment tool 300, and rolling the knives up in unison to the alignment posts 320. The alignment tool 300 may be particularly useful for initial positioning of the knives on the cutterhead, or following sharpening. The nuts 150 on the attachment elements 140 may be tightened, securing each knife 160 in the desired position. The alignment tool 300 may be used to ensure that the cutting edge 162 of each knife 160 extends to the same radial position from the cutter head 200. Thus, each knife 160 performs an equal amount of work, removing an equal amount of material during each cut.

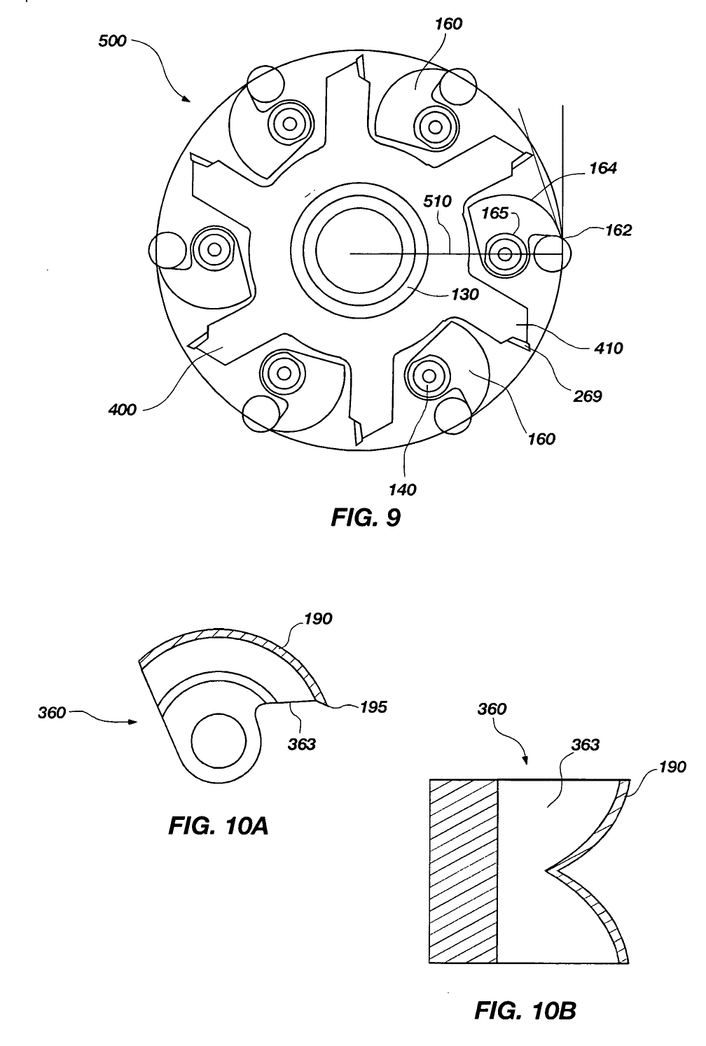

Another embodiment of the present invention is depicted in FIG. 9. Mounted about the arbor collar 130 of the cutterhead 500 is a multi-knife pinwheel 400. The pinwheel 400 may include protrusions 410 having separable tips 269 mounted thereon. Interspersed between the protrusions 410 may be knives 160, mounted upon attachment elements 140, as described hereinabove. The protrusions 410 having the separable tips 269 may be configured to mimic a portion of the profile of the knives 160, for example if portions of the workpiece are expected to include harder materials. Alternatively, the protrusions 410 may be configured to remove additional material from the workpiece, adding to the profile shape of the knives 160.

FIG. 9 additionally illustrates the positioning of the knives 160 on the cutterhead 500. The cutting edge 162 of the knife 160 is not positioned on the radial line 510 extending from a central location of the cutterhead 500 through a central location of the knife bore 165. The knife 160 is positioned to enable cutting clearance behind the cutting edge 162. There is relief behind the cutting edge 162, as the back surface 164 drops away from the outside edge of the cutterhead 500. The relief enables the knife 160 mounted on the cutterhead 500 to have cutting properties.

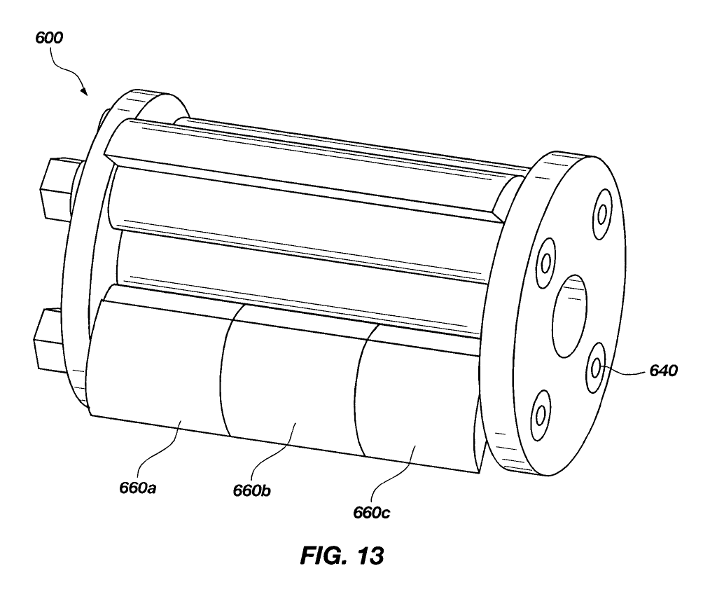

Another embodiment of a knife 460 of the present invention is depicted in FIG. 11. The knife 460 has a substantially planar cutting edge 362; however, the cutting edge 462 has a textured relief. The knife 360 may be useful for forming a relief in a synthetic wood product. Synthetic wood may be formed from a blend of high density polyethylene plastic and sawdust. The synthetic wood may be extruded in the desired shape such as a board. It may be desirable to have a synthetic wood product with the texture and relief of wood grain. Conventionally, warm synthetic wood may be brushed with a wire wheel to form the desired texture. However, brushing the warm, synthetic wood may produce a dimensionally unstable and erratic texture. The knife 460 of the present invention may be used to cut a reliably reproducible texture into a synthetic wood material.

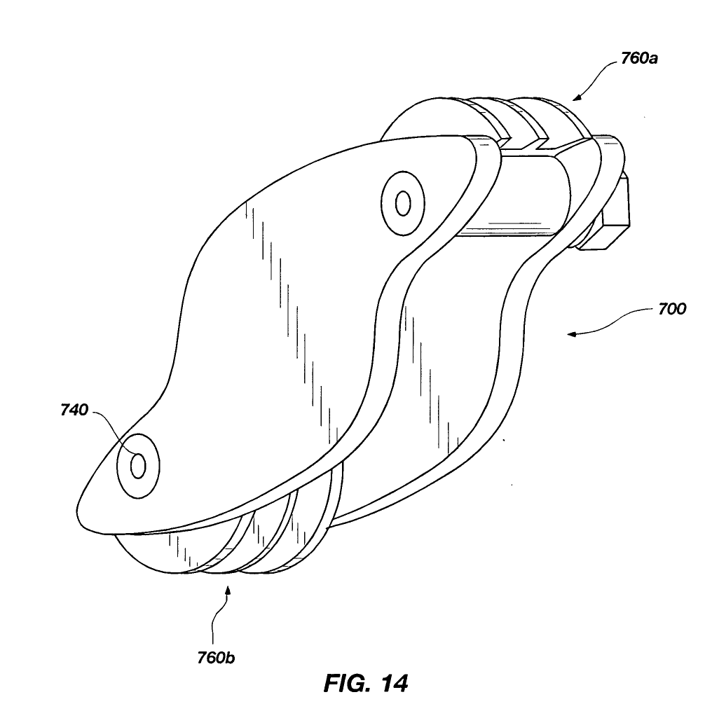

Yet another embodiment of the present invention is depicted in FIG. 12. A plurality of knives 560a, 560b, 560c, 560d, 560e may be stacked on an attachment element 140, and may be used to cut a thicker material. The profile of the stacked knives of FIG. 12 include at least one central knife 560b, 560c, 560d and a knife 560a, 560e having a concave profile at either end. The stack of knives 560a, 560b, 560c, 560d, 560e may be used to cut eased edges on a board. Each knife 560a, 560b, 560c, 560d, 560e may have a substantially similar thickness. For example, each knife may have a cutting edge about three (3) inches (7.6 centimeters) long. The embodiment depicted in FIG. 12 includes five (5) knives, and may be useful to chamfer the edges of a board about 15 inches (38.1 centimeters) thick. Stacked knives may be configured to chamfer the edges of conventionally sized lumber, for example 2×4 and 2×6 boards, both wood and synthetic. Stacked knives, with each knife having a different profile are also within the scope of the present invention. For example a stack of knives may alternate, with a knife having a straight profile stacked between knives having serrated profiles.

The knives 160 of the present invention may shorten the time required to cut a profile in a plurality of workpieces, and eliminate the costs associated with conventional, planar, disposable insert knives because the knives 160 have a longer run time without sharpening, and may be resharpened and aligned with tight tolerances on the cutterhead. Less down time of the machinery may be required for sharpening the knives as compared to replacing and aligning conventional knives. For example, the same total length of workpieces may be cut to a desired profile in 24 to 48 hours using a cutterhead and knife of the present invention as would be cut in two (2) to four (4) days using a conventional cutterhead and knife. Additionally, the knives 160 of the present invention may be useful for cutting a piece of wood at the end grain, or with the grain. That is, the end grain surface of the wood may be cut into the desired profile, or the flat grain surface of the wood may be cut into the desired profile.

The tolerances of a cutterhead 200 and knife 160, 160′, 160a, 160b, 260 360, 460, 560, 660, 760 of the present invention are very tight. The knives 160, 160′, 160a, 160b, 260, 360, 460, 560, 660, 760 may hold a ±0.001 inch runout on a workpiece. That is, the cutting depth will only vary ±0.001 inch from the desired profile depth on the workpiece. The attachment elements 140, 240, 640 may be precisely aligned within the center of the apertures 115 of the annular end plates 110, 120, 210, 220 to within ±0.001 inch. The knives 160, 160′, 160a, 160b, 260, 360, 460, 560, 660, 760 fit over the attachment elements 140, 240, 640 with a tolerance of only a few thousandths of an inch.

Any number of knives 160, 160′, 160a, 160b, 260, 360, 460, 560, 660, 760 may be circumferentially spaced about a cutterhead 100, 200, 500, 600, 700. For example, two (2), four (4) six (6), eight (8), or as many as twenty (20) knives 160 may be included on a single cutterhead 100, 200, 500, 600, 700. FIG. 13 depicts a cutterhead 600 having four (4) attachment elements 640, each attachment element 640 having three (3) knives 660a, 660b, 660c stacked thereon. The stacked knives 660a, 660b, 660c are configured for cutting a substantially linear profile and forming a substantially planar surface on a workpiece. FIG. 14 depicts a wing-shaped cutterhead 700 having two (2) attachment elements 740, each attachment element 740 having a single knife 760a, 760b disposed thereon. The knives 760a, 760b are each mounted at opposing ends of the wing-shaped cutterhead 700.

The knives 160, 160′, 160a, 160b, 360, 460, 560, 660, 760 of the present invention are safer than conventional profile knives. Conventional profile knives may include knife inserts which may be clamped or screwed in place. These clamps and screws may loosen or detach during cutting operations, which may cause injury to operators and equipment. In contrast, the knives 160, 160′, 160a, 160b, 360, 460, 560, 660, 760 of the present invention are attached to the cutterhead 100 with attachment elements 140 secured through apertures 115 of the cutterhead 100 and a bore 165 through each knife 160.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. A knife for cutting a profile, comprising:
a cutting face including a cutting edge in the shape of a profile to be cut into a workpiece, the profile including at least one protrusion;
a bore through the knife for mounting the knife on a rotary cutterhead, the bore oriented parallel to the substantially planar cutting face; and
a back surface adjacent the cutting face and including the cutting edge, the back surface contoured in the shape of the profile and partially radially encompassing the bore.

2. The knife of claim 1, wherein the back surface includes a concave surface.

3. The knife of claim 1, wherein the back surface includes a convex surface.

4. The knife of claim 1, wherein the back surface includes a depressed portion distal from the substantially planar cutting face.

5. The knife of claim 1, wherein the back surface includes a coating thereon.

6. The knife of claim 5, wherein the coating comprises zirconium nitride.

7. The knife of claim 1, wherein the back surface is concentric with respect to an axis located centrally through the bore.

8. A method of sharpening a profile knife, comprising:
providing a cutterhead having a plurality of profile knives annularly attached thereto;
grinding a cutting surface of each profile knife of the plurality to provide a cutting edge in the shape of a profile to be cut in a workpiece; and
aligning the plurality of profile knives with the cutting edge of each profile knife extending radially a substantially similar distance from the cutterhead.

9. A cutterhead for cutting a profile in a workpiece, comprising:
an arbor collar;
a first plate mounted on a first end of the arbor collar, the first plate having a first plurality of spaced apertures therethrough;
a second plate mounted on a second end of the arbor collar, the second plate having a second plurality of spaced apertures therethrough;
at least one attachment element, the at least one attachment element mounted through an aperture of the first plurality and an aperture of the second plurality; and
a knife mounted on the at least one attachment element between the first plate and the second plate, the knife comprising:
a cutting face including a cutting edge in the shape of a profile to be cut into a workpiece;
a back surface adjacent the cutting face and including the cutting edge, the back surface contoured in the shape of the profile; and
a bore through the knife for mounting the knife on the attachment element, the bore oriented parallel to the substantially planar cutting face.

10. The cutterhead of claim 9, wherein the at least one attachment element includes an automotive taper.

11. The cutterhead of claim 10, wherein the back surface of the knife includes a coating thereon.

12. The cutterhead of claim 11, wherein the coating on the back surface of the knife comprises zirconium nitride.

13. The cutterhead of claim 9, wherein the arbor collar includes a star-shaped perimeter.

14. The cutterhead of claim 9, wherein the arbor collar includes a grease fitting on a circumferential surface thereof.

15. The cutterhead of claim 9, wherein the arbor collar includes a tapered bore therethrough.

16. The cutterhead of claim 9, further comprising at least a second knife mounted in a stacked formation with the knife on the at least one attachment element

17. A knife for cutting a profile, comprising:
a cutting face including a cutting edge having at least one protrusion and at least one valley;
a bore through the knife for mounting the knife, the bore having an off-center position in the knife; and
a back surface adjacent the cutting face and including the cutting edge, the back surface following the shape of the at least one protrusion and the at least one valley in cylindrical relief.

18. The knife of claim 17, wherein the back surface includes a depressed portion distal from the substantially planar cutting face.

19. The knife of claim 17, wherein the back surface includes a coating thereon.

20. The knife of claim 19, wherein the coating comprises zirconium nitride.

21. The knife of claim 17, wherein the cutting edge comprises a plurality of erratic hills and valleys.

22. The knife of claim 17, wherein the cutting edge is configured to form a woodgrain-like texture on a workpiece.

23. The knife of claim 17, wherein the cutting edge includes a height at least half of a width of the knife.

24. The knife of claim 17, wherein the back surface is concentric with respect to an axis located centrally through the bore.
